(19) United States
(12) Patent Application Publication
(10) Pub. No.: US 2007/0280155 A1
(43) Pub. Date: Dec. 6, 2007

(54) Device and method for optimizing communications in a wireless network

(76) Inventors: Vinh-Phuong Tra Le, Fremont, CA (US); Dean Kawaguchi, San Jose, CA (US)

Correspondence Address: FAY KAPLUN & MARCIN, LLP, 15O BROADWAY, SUITE 702, NEW YORK, NY, 10038, US

(21) Appl. No.: 11/445,882

(22) Filed: Jun. 2, 2006

(51) Int. Cl. H04Q 7/00

(52) U.S. Cl. 370/328

(57) ABSTRACT

Described is a device and method for optimizing communications in a wireless network. The device comprises a first wireless transceiver communicating using a first channel of a first frequency band, a second wireless transceiver communicating using a second channel of a second frequency band, and a processor selecting one of the first and second transceivers for transmission of a wireless signal to a further device as a function of destination data of the further device. The further device includes a third transceiver communicating using one of the first and second frequency bands.

### FIELD OF INVENTION

The present invention relates generally to optimizing communications in wireless environments.

### BACKGROUND

In a conventional wireless mesh network, all of the mesh nodes utilize a single channel on a particular frequency band for communication with mobile units and other mesh nodes. For example, in wireless communications conducted in accordance with an IEEE 802.11 standard, access points implemented as the mesh nodes may communicate at 2437 MHz (i.e., channel 6 on a 2.4 GHz band). According to a medium access mechanism defined in the 802.11 standard (i.e., CSMA/CA), only a single mesh node within a particular coverage area may utilize the channel at one time. Because all of the mesh nodes and MUs within the coverage area are configured to communicate on the same channel, they must wait until the mesh node relinquishes control of the channel before re-attempting to gain access thereto. This can result in relatively low throughput in the mesh network. Furthermore, wireless communication according to the 802.11 standard is a half-duplex operation, i.e., only transmitting or receiving occurs on the channel at one time, which further limits the throughput in the mesh network.

### SUMMARY OF THE INVENTION

The present invention relates to a device and method for optimizing communications in a wireless network. The device comprises a first wireless transceiver communicating using a first channel of a first frequency band, a second wireless transceiver communicating using a second channel of a second frequency band, and a processor selecting one of the first and second transceivers for transmission of a wireless signal to a further device as a function of destination data of the further device. The further device includes a third transceiver communicating using one of the first and second frequency bands.

### BRIEF DESCRIPTION OF THE DRAWINGS

FIG. 1 shows an exemplary embodiment of a system for optimizing communications in a wireless network according to the present invention.

FIG. 2 shows an exemplary embodiment of a method for optimizing communications in a wireless network according to the present invention.

### DETAILED DESCRIPTION

The present invention may be further understood with reference to the following description and the appended drawings, wherein like elements are provided with the same reference numerals. The present invention describes a system, device and method for optimizing communications in a wireless network. While the exemplary embodiment of the present invention will be described with reference to a wireless mesh network and optimizing wireless communications at nodes in the mesh, those of skill in the art will understand that the present invention may be utilized in any wireless environment and by any wireless device.

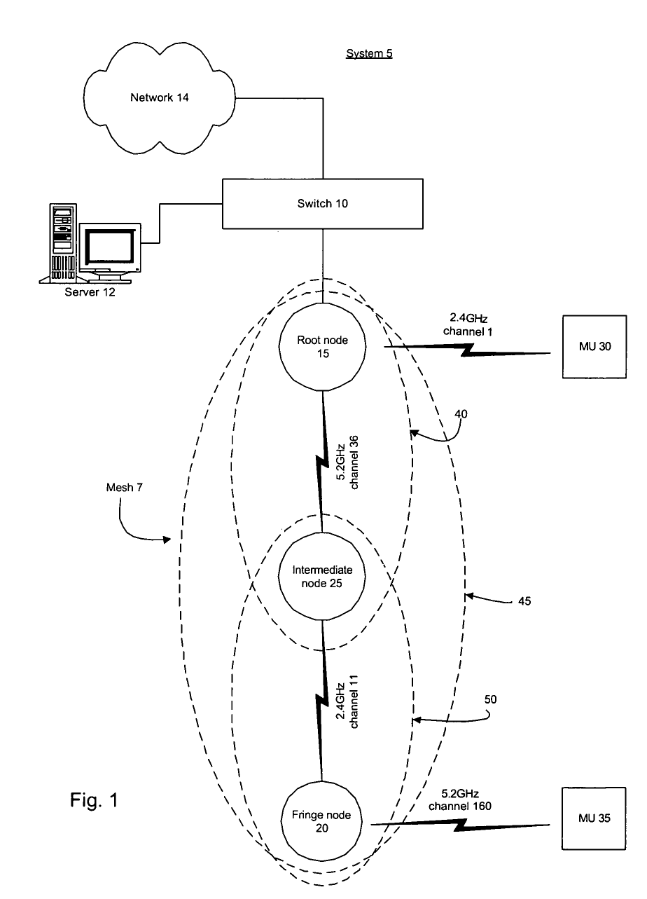

FIG. 1 shows an exemplary embodiment of a system 5 according to the present invention. The system 5 comprises a wireless mesh 7 including a network management arrangement (e.g., a switch 10) communicatively coupled to a plurality of mesh nodes which may referred to as root, intermediate or fringe nodes based on distance from the switch 10. For example, a root node 15 is the mesh node closest to the switch 10, while a fringe node 20 is the mesh node furthest from the switch 10. That is, a packet transmitted by the fringe node may be received and retransmitted by at least one further mesh node and the root node 15 before reaching the switch 10. An intermediate node 25 is the at least one mesh node between the root node 15 and the fringe node 20. Those of skill in the art will understand the mesh 7 may include any number of nodes in any configuration, and transmission of wireless signal in the mesh 7 may follow optimizeable transmission paths (e.g., signals travel through a least number of nodes to reach the switch 10 and/or destination node).

In the exemplary embodiment, the switch 10 may be deployed in an indoor environment (e.g., a building, warehouse, etc.), while the mesh nodes are deployed in an outdoor environment (e.g., a shipping yard, a parking lot, etc.). The switch 10 may be coupled to a server 12 and a communications network 14 (e.g., a LAN, an intranet, the Internet, etc.). The mesh 7 provides access to the communications network 14 for users of mobile computing units (MUs), e.g., MU 30 and MU 35, in the outdoor environment. Those of skill in the art will understand that the system 5 may be deployed wholly or partially in the indoor and/or outdoor environments.

The switch 15 may be an Ethernet switch/hub or a wireless switch and uses the root node 10 as a means for communicating with the nodes in the mesh 7, while the nodes utilize the root node 10 as a means for communicating with the switch 10. For example, all packets from the mesh 7 which are bound for the switch 10, the server 12 and/or the network 14 may be funneled through the root node 15.

Wireless communications in the mesh 7 may be executed according to a predetermined wireless communication protocol, e.g., an IEEE 802.1x protocol. As known by those of skill in the art, the 802.1x protocol defines a CSMA/CA mechanism to limit congestion on a radio frequency channel utilized for wireless communications. As describe above, in a conventional mesh network, all of the mesh nodes utilize a single channel for wireless communications. This may result in low throughput and interference in the mesh network. According to the exemplary embodiments of the present invention, the mesh nodes utilize channels on at least two frequency bands (e.g., 2.4 GHz and 5.2 GHz) for conducting wireless communications to increase throughput without interference.

As is known in the art, each of the mesh nodes transmits and receives wireless signals in a predetermined wireless coverage area. As shown in FIG. 1, the root node 15 has a coverage area 40, the intermediate node 25 has a coverage area 45 and the fringe node 20 has a coverage area 50. During deployment of the mesh 7, the mesh nodes are arranged so that the coverage areas overlap, ensuring that the mesh nodes can communicate wireless signals with each other and that wireless connectivity is provided (without coverage gaps) to MUs in the system 5. For example, the coverage area 50 of the fringe node 20 must include at least one further mesh node (e.g., the intermediate node 25) so that the fringe node 20 can maintain connectivity (and a transmission path) to the switch 10. Thus, the fringe node 20 may transmit a packet bound for the switch 10 directly to the intermediate node 25 but not directly to the root node 15, because its coverage area 50 does not include the root node 15.

In a conventional mesh network, a root node, upon gaining access to a channel, transmits a packet bound for a fringe node to an intermediate node. Upon receipt of the first packet, the intermediate node would attempt to transmit the first packet to the fringe node. However, the root node may still have control of the channel. Thus, the intermediate node must wait until the root node relinquishes control of the channel before attempting to transmit the first packet. Delay is introduced at the intermediate node, because it cannot transmit the packet to the fringe node or communicate with any MUs associated therewith. Additional delay is introduced for MUs associated with the root node which have packets to transmit thereto. Even if the intermediate node could retransmit the packet to the fringe node immediately upon receipt thereof, the additional delay may still be present. That is, the MUs associated with the root node would have to wait to transmit their packets, because the intermediate has control of the channel. As a result, in the conventional mesh network, throughput decreases as packets propagate through multiple nodes.

According to the exemplary embodiments of the present invention, throughput in the mesh 7 may be increased by utilizing mesh nodes which are capable of communicating simultaneously on channels of at least two different frequency bands (e.g., the 2.4 GHz band and the 5.2 GHz band). That is, each mesh node may utilize two transceivers, each of which is configured to communicate on a respective channel of a respective frequency band. As will be described below, each mesh node assigns a first channel on a first frequency band for communication with MUs and a second channel on a second frequency band for backhaul transfer (e.g., communication with other mesh nodes, the switch 10, etc.). The assignments may be designated manually by a system operator when, for example, deploying the mesh nodes, or may be designated automatically when the mesh node boots. When a mesh node receives a wireless signal, it selects one of the transceivers to retransmit the signal based on a destination thereof. That is, when the designations is an MU associated with the mesh node, it retransmits the signal on the first channel, and when the destination is another mesh node (or the switch 10) it transmits the signal on the second channel. The mesh node may store data indicative of destinations and the corresponding channel for communications.

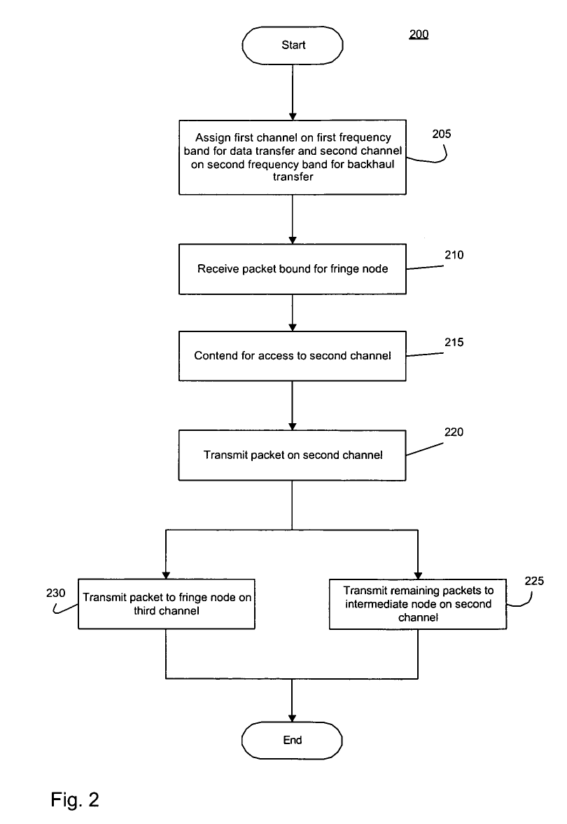

FIG. 2 shows an exemplary embodiment of a method 200 for conducting wireless communications in a wireless mesh network according to the present invention. Although, the exemplary embodiment of the method 200 will be described as transmitting a packet downstream (e.g., from the root node 15 to the fringe node 20), those of skill in the art will understand that the present invention may be implemented for upstream and downstream communication on any mesh node and for any type of packet. Also, in the exemplary embodiment, the mesh nodes (e.g., nodes 15-25) will be described as capable of communicating on channels on two different frequency bands. However, those of skill in the art will understand that the present invention may be utilized by mesh nodes which utilize more than two frequency bands.

In step 205, the root node 15 assigns a first channel (e.g., channel 1) on a first frequency band (e.g., the 2.4 GHz band) and for communication with MUs (e.g., the MU 30) associated with the root node 15. Thus, when the root node 15 and the MU 30 have packets to transmit to each other, they would both contend for access to the first channel. In a similar manner and also in step 205, the root node 15 assigns a second channel (e.g., channel 36) on a second frequency band (e.g., the 5.2 GHz band) for backhaul communications, i.e., with other mesh nodes, with the switch 10, etc. Thus, when the root node 15 and the intermediate node 25 both have packets to transmit to each other, they would both contend for access to the second channel. Each node in the mesh 7 may perform a similar assignment process when being deployed and/or after booting. Those of skill in the art will understand that the selection of a channel on a particular frequency band is based on activity on other channels of the band.

In an exemplary embodiment in which the mesh node automatically assigns channels for communications, the mesh node may, upon powering up, scan the channels on the frequency bands for activity. For example, when the fringe node 20 is deployed, it may scan the channels on the 2.4 GHz and 5.2 GHz bands. In the exemplary embodiment, the fringe node 20 detects activity on channel 36 of the 5.2 GHz band (i.e., communications between the root and intermediate nodes) and, potentially, activity on one or more channels of the 2.4 GHz band if the intermediate node 25 is communicating with any MUs associated therewith or other mesh nodes. As shown in FIG. 1, the fringe node 20 assigns channel 160 of the 5.2 GHz band for communication MUs (e.g., the MU 35) so that there is no interference with the communications on channel 36 of the 5.2 GHz band. The fringe node 20 may assign a channel for backhaul communications with the intermediate node 25 which is already being used by the intermediate node (e.g., channel 11 on the 2.4 GHz band) or may assign a different channel on the 2.4 GHz band for the backhaul communications. The fringe node 20 would use a different channel on the 2.4 GHz band, because the 5.2 GHz band has previously been assigned for communications with the MUs.

In step 210, the root node 15 receives a packet addressed to the fringe node 20. The packet may have been transmitted from the MU 30, the switch 10 or a mesh node communicatively coupled to the root node 15. Those of skill in the art will understand that for each packet received by the root node 15 it may determine a destination of the packet and select a corresponding channel for the transmission of the packet. That is, for a packet addressed to the MU 30, the root node 15 may take steps (similar to those described below for transmitting on the second channel) for transmitting the packet to the MU 30 on the first channel on the first frequency band, e.g., channel 1 of 2.4 GHz band.

In step 215, the root node 15 contends for access to the second channel using, for example, the conventional methods implemented in the CSMA/CA mechanism. Because only the intermediate node 25 (and other mesh nodes who communicate with the root node 15 on the second channel and have coverage areas which overlap the coverage area 40) may be contending for the second channel, access thereto may be gained relatively quickly. For example, the intermediate node 25 may be transmitting a packet to the root node 15 on the second channel when the root node 15 attempts to gain access thereto.

In step 220, the root node 15 gains access to the second channel and transmits the packet to the intermediate node 25. In step 225, the root node 15 may maintain control of the second channel and transmit remaining packets in the series of packets to the intermediate node 25. As described above with reference to the conventional mesh network, the intermediate node 25 would have to wait for the root node 15 to relinquish control of the second channel before forwarding the packet to the fringe node 20.

According to the present invention, as shown in step 230, the intermediate node 25 may, simultaneously with step 225, forward the packet to the fringe node 20 and receive the remaining packets from the root node 15. The intermediate node 25 may utilize a third channel (e.g., channel 11) on the first frequency band to communicate backhaul transfer with the fringe node 20. Because the root node 15 is communicating with the MU 30 on the channel 1 of the 2.4 GHz band, the intermediate node 25 selects the channel 11 of the 2.4 GHz band so that there is no interference between transmissions by the root node 15 to/from the MU 30 and the intermediate node 25 to/from the fringe node 20—same frequency band, different channel. In addition, there will not be any interference between transmission by the root node 15 to/from the MU 30 and the root node 15 to/from the intermediate node 25—different frequency band.

As shown in FIG. 1, when the fringe node 20 receives the packet, it may forward the packet to the MU 35 on a fourth channel (e.g., channel 160) on the second frequency band. Thus, there would be no interference with communications between the intermediate node 25 and the root node 15 which occur on the channel 36 on the 5.2 GHz band. Remaining mesh nodes may be deployed in a similar manner as described with reference to the root, intermediate and fringe nodes so that each mesh node may communicate with associated MUs and other mesh nodes within its wireless coverage area without interference.

Simultaneous use of channels on at least two different frequency bands increases throughput in the mesh 7. That is, in a conventional wireless network in which all of the mesh nodes utilize only a single frequency channel, all mesh nodes contend for access to the single channel. Thus, after the root node transmits the packet to the intermediate node, both nodes would contend for access to the single channel (decreasing throughput), and, when one node gets access to the single channel, the other node (and MUs associated with the root and intermediate nodes) must wait until the channel is free (causing a further decrease in throughput). According to the present invention, the intermediate node 25 (and any other mesh node and/or wireless device) may utilize at least two channels on two frequency bands to eliminate or substantially reduce the delays existent in the conventional networks.

The present invention has been described with reference to an exemplary embodiment. One skilled in the art would understand that the present invention may also be successfully implemented, for example, in alternative embodiments. Accordingly, various modifications and changes may be made to the embodiments without departing from the broadest spirit and scope of the present invention as set forth in the claims that follow. The specification and drawings are accordingly to be regarded in an illustrative rather than restrictive sense.

What is claimed is:

1. A device, comprising:
a first wireless transceiver communicating using a first channel of a first frequency band;
a second wireless transceiver communicating using a second channel of a second frequency band; and
a processor selecting one of the first and second transceivers for transmission of a wireless signal to a further device as a function of destination data of the further device,
wherein the further device includes a third transceiver communicating using one of the first and second frequency bands.

2. The device according to claim 1, wherein a further wireless signal is received by the other transceiver of the first and second transceiver, the further signal being simultaneously received with the transmission of the signal.

3. The device according to claim 1, wherein the processor determines a destination of the wireless signal as a function of the destination data.

4. The device according to claim 1, wherein the device is a wireless mesh node, and the further device is one of a further wireless mesh node and a mobile communication device.

5. The device according to claim 4, wherein each of the wireless mesh node and the further wireless mesh node is one of an access point and an access port.

6. The device according to claim 1, wherein the first frequency band is one of a 2.4 GHz band and a 5.2 GHz band, and the second frequency band is the other of the 2.4 GHz band and the 5.2 GHz band.

7. A method, comprising:
receiving, by a first wireless transceiver, a wireless signal on a first channel of a first frequency band;
selecting one of the first and a second wireless transceiver for transmission of the signal to a wireless device as a function of destination data of the wireless device, the second transceiver communicating using a second channel of a second frequency band, the wireless device including a third wireless transceiver communicating using one of the first and second frequency bands; and
transmitting the wireless signal to the wireless device using the selected transceiver.

8. The method according to claim 7, further comprising:
receiving a further wireless signal by the other transceiver of the first and second transceivers simultaneously with the transmitting of the wireless signal.

9. The method according to claim 7, further comprising:
determining a destination of the wireless signal as a function of the destination data.

10. The method according to claim 7, wherein the wireless device is one of a wireless mesh node and a mobile communication device.

11. The method according to claim 10, wherein the wireless mesh node is one of an access point and an access port.

12. The method according to claim 7, wherein the first frequency band is one of a 2.4 GHz band and a 5.2 GHz band, and the second frequency band is the other of the 2.4 GHz band and the 5.2 GHz band.

13. A system, comprising:
a wireless mesh node receiving a wireless signal on a first channel of a first frequency band using a first wireless transceiver, the wireless mesh node including a second wireless transceiver communicating using a second channel of a second frequency band; and
a wireless device including a third wireless transceiver communicating using one of the first and second frequency bands;
wherein, the mesh node selects one of the first and second transceivers for transmission of the signal to the wireless device as a function of destination data of the wireless device and transmitting the wireless signal to the wireless device using the selected transceiver.

14. The system according to claim 13, wherein the mesh node receives a further wireless signal simultaneously with the transmission of the signal.

15. The system according to claim 13, wherein the wireless mesh node is one of an access point and access port.

16. The system according to-claim 13, wherein the wireless device is one of a wireless mesh node and a mobile communications device.

17. The system according to claim 16, wherein the mobile communications device includes at least one of an imager-based scanner, a laser-based scanner, an RFID reader, an RFID tag, a mobile phone, a PDA and a network interface card.

18. The system according to claim 13, wherein the first frequency band is one of a 2.4 GHz band and a 5.2 GHz band, and the second frequency band is the other of the 2.4 GHz band and the 5.2 GHz band.

19. The system according to claim 13, further comprising:
a network management arrangement communicatively coupled to one of the mesh node and the wireless device.

20. The system according to claim 13, wherein the network management arrangement is one of an Ethernet switch, an Ethernet hub and a wireless switch.

21. A device, comprising:
a first wireless communication means for communicating using a first channel of a first frequency band;
a second wireless communication means for communicating using a second channel of a second frequency band; and
a processing means for selecting one of the first and second wireless communication means for transmission of a wireless signal to a further device as a function of destination data of the further device,
wherein the further device includes a third wireless communication means for communicating using one of the first and second frequency bands.
